(19) United States
(12) Patent Application Publication
(10) Pub. No.: US 2014/0030681 A1
(43) Pub. Date: Jan. 30, 2014

(54) Activity-oriented Studying Method in an Online-to-offline Manner

(71) Applicant: Two Cents Technology Corp., Taipei City (TW)

(72) Inventor: Shih-Pai Lee, Taipei City (TW)

(73) Assignee: Two Cents Technology Corp., Taipei City (TW)

(21) Appl. No.: 13/950,361

(22) Filed: Jul. 25, 2013

(30) Foreign Application Priority Data
Jul. 27, 2012 (TW) 101127217

(51) Int. Cl. G09B 5/00; G06Q 50/20

(52) U.S. Cl. CPC G09B 5/00; G06Q 50/20
USPC 434/127; 705/21; 705/14.49

(57) ABSTRACT

An activity-oriented studying method in an online-to-offline manner is suitable for athlete training, language learning, weight management, health management, potential development or in-depth travel. The activity-oriented studying method includes providing a network platform and a physical storefront, and selecting a coach on the network platform by a user, and recommending a personal course to the user according to a study record of the user on the network platform by the coach. The activity-oriented studying method further includes confirming the personal course on the network platform by the user, so that the user attends an interactive class with the coach face to face in the physical storefront. After the course, the activity-oriented studying method further includes updating the study record via the network platform by the user, and grading the user via the network platform so as to record a grade of the user into the study record by the coach.

### BACKGROUND OF THE INVENTION

1. Field of the Invention

The present invention relates to a studying method, and more particularly, to an activity-oriented studying method in an online-to-offline (O2O) manner.

2. Description of the Prior Art

Conventional studying method, such as course learning and language learning, is a kind of standardized learning method, which has advantages of fair competition and impersonal scoring standard. The conventional studying method is not suitable for students who need specific adjustment according to specific situations. In past days, a personal studying mode with the specific adjustment according to the specific situations is accomplished by the system of a master and a few apprentices. The master provides training course according to apprentices' intelligence, and adjusts teaching skills and content of the course according to scheduled progress and feedback from the apprentices. However, the modern society tends towards standardized training education, and the personal studying mode by the apprenticeship becomes infrequent.

Due to the mature virtual information network, the mobile economy and the digital publication technology, lots of industries, such as Google, Apple, Microsoft, Amazon, Udemy, Learnable, Tencent, Hanvon and so on, seek a solution about online learning course. Unfortunately, the conventionally accomplished method only transfers the former content/mode to the network directly. The SoLoMo (illustrating a combination of Social factor, local factor and mobile factor) develop platform and commercial mode are not utilized to reinvent the conventional studying method.

### SUMMARY OF THE INVENTION

The present invention provides the O2O activity-oriented studying method, which utilizes SoLoMo notion and apprenticeship to advance the conventionally rigid studying method.

According to the claimed invention, an activity-oriented studying method in an O2O manner is disclosed. The activity-oriented studying method includes providing a network platform and a physical storefront, selecting a coach on the network platform by a user, and recommending a personal course to the user according to a study record of the user on the network platform by the coach. The personal course includes a personal teaching material, and the personal teaching material includes a part of content or whole content of at least one basic teaching material. The activity-oriented studying method further includes confirming the personal course on the network platform by the user, so that the user attends an interactive class with the coach face to face in the physical storefront. After the course, the activity-oriented studying method further includes updating the study record via the network platform by the user, and grading the user via the network platform so as to record a grade of the user into the study record by the coach.

According to an embodiment of the claimed invention, the activity-oriented studying method further includes setting a target according to a situation of the user in the interactive class by the coach, and studying voluntarily according to the target by the user after leaving the physical storefront and updating the study record via the network platform. The activity-oriented studying method further includes selecting the coach or the personal course via the network platform according to a referee by the user, wherein the referee has attended the interactive class, and then, providing a referral fee to the referee by the network platform because the user selects the coach or the personal course due to recommendation of the referee. Relation between the referee and the user belongs to relation between an upline and a downline of a direct selling mode, so that a grant of the referral fee conforms to a grant of the direct selling mode. The activity-oriented studying method further includes making an achievement of the taught user and the related study record via the network platform by the coach for advertisement, and making an e-book of the used personal course, the personal teaching material and the related study record via the network platform by the user for selling on the network platform.

According to an embodiment of the claimed invention, the activity-oriented studying method further includes at least one point-of-sale (POS) system and at least one terminal device. Each POS system is disposed on the corresponding physical storefront and can be communicated with the network platform. The terminal device has network function to be communicated with the corresponding POS system, so as to help the user to obtain identification via the POS system and therefore consume in the physical storefront or attend the interactive class with the coach, or so as to help the user to login the POS system or the network platform for searching and selecting the coach or the personal course and for updating the study record of the user. The network platform includes at least one member central system and a data central system. Each member central system is in charge of member management and data collection of an organization. Each member central system is communicated with the POS system disposed on at least one physical storefront of multiple physical storefronts of the organization. The data central system can analyze information from the at least one member central system, so as to generate an advertisement or a publication in electronic format to the at least one member central system or to its member.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of the O2O activity-oriented studying system according to an embodiment of the present invention.

FIG. 2 is a flow chart of the O2O activity-oriented studying method according to the embodiment of the present invention.

FIG. 3 is a diagram of paying the referral fee of the O2O activity-oriented studying method according to the embodiment of the present invention.

### DETAILED DESCRIPTION

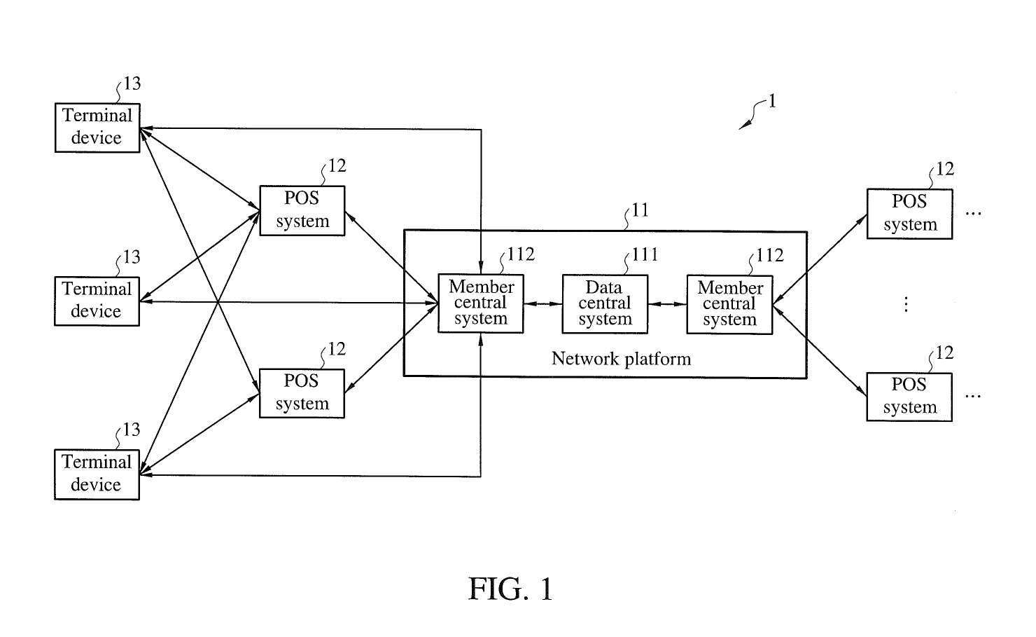

FIG. 1 is a diagram of an O2O activity-oriented studying system according to an embodiment of the present invention. Referring to FIG. 1, the O2O activity-oriented studying system 1 is suitable for athlete training, language learning, weight management, health management, potential development or in-depth travel, etc. The O2O activity-oriented studying system 1 includes a network platform 11, a POS system 12 and a terminal device 13. The network platform 11 includes a data central system 111 and a member central system 112. Each member central system 112 is in charge of member management and data collection of an organization. The organization can be a company for the weight/health management, a service platform for the language learning, and members of the organization includes the coach and the user. The data central system 111 analyzes information from the member central system 112, so as to generate an advertisement or a publication in electronic format to the member central system 112 or to its members.

Each member central system 112 is communicated with the POS system 12 disposed on the at least one multiple physical storefront of the organization. Each physical storefront has a person in charge. The terminal device 13 can be an electronic device with network function, such as the watch, the notebook computer, the desktop computer, the pedometer disposed on the shoes, and the weight meter.

For example, after the user utilizes the mobile phone to obtain identification via the POS system 12, the user can enter the physical storefront to consume or attend an interactive class with the coach face to face. Further, the user can utilize the mobile phone, the notebook/desktop computer to login the POS system 12 to search an activity and related information of the physical storefront, the own consumer history in the physical storefront, and conditions of the friends in the same group. The user further can login the member central system 112 to search and select the coach or the personal course, to search and update the latest study record actively. In addition, the user can utilize the pedometer disposed on the shoes and the weight meter to passively update the study record.

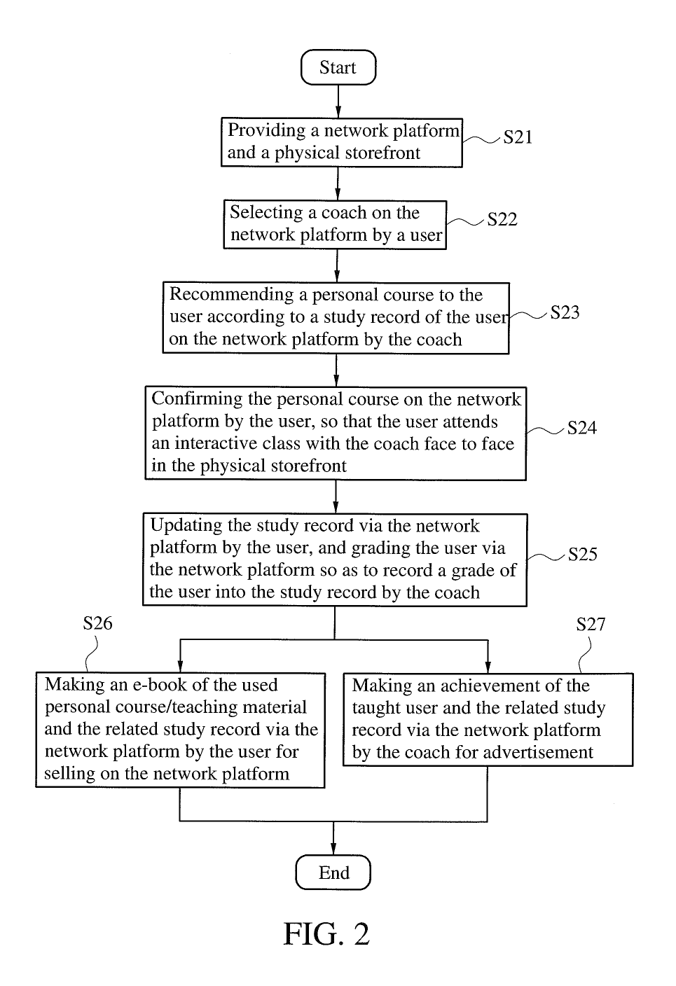

FIG. 2 is a flow chart of the O2O activity-oriented studying method according to the embodiment of the present invention. Referring to FIG. 2, the O2O activity-oriented studying system 1 shown in FIG. 1 can be applied to the weight management. Step S21 is executed to provide the network platform 11 and the physical storefront whereon the POS system 12 is disposed.

In step S22, the user A1 can find out the O2O activity-oriented studying system 1 from newspaper, magazine or advertisement. The terminal device 13 with the network function, such as the desktop computer, is utilized to login the member central system 112 of the network platform 11. The user selects the coach or the existed personal course via the member central system 112, or selects the recommended coach C1 or the personal course recommended by the coach C1 due to recommendation of the referee B1. The referee B1 has to attend the interactive class with the recommended coach face to face, so as to prevent the referee B1 from giving random rerecommendation animus without actual learning experience. Meanwhile, the network platform 11 can provide a referral fee to the referee B1 because the user A1 selects the coach C1 or the personal course due to the recommendation of the referee B1. The referee B1 can be the person in charge, the other user, the coach and so on.

In step S23, the coach C1 recommends the personal course to the user A1 according to the study record of the user on the member central system 112 of the network platform 11. The personal course includes at least one training course and a related personal teaching material, such as a series of training courses and the related personal teaching materials. Each personal teaching material includes a part of content or whole content of at least one basic teaching material. Each basic teaching material can be the material published by the data central system 111 of the network platform 11, or the other material cooperated with the other publisher. These materials include a plurality of chapters with different subjects. The coach C1 can determine current level, intelligence, comprehension of the user A1 according to study record of the user A1 stored in the member central system 112 of the network platform 11, to make the personal teaching material suitable for the user A1. The personal teaching material can be directly obtained from the basic teaching material, or can be partly obtained from a part of content or whole content of one basic teaching material and further be partly obtained from a part of content or whole content of the other basic teaching material. As the user A1 uses the personal teaching material recommended by the coach C1, the user A1 has to pay for copyright of the personal teaching material. The network platform 11 can provide the referral fee to the coach C1 when the user A1 selects the personal teaching material recommended by the coach C1.

In step S24, the user A1 selects the personal course designed by the coach C1 via the member central system 112 of the network platform 11, the user A1 can utilize the terminal device 13 to obtain identification via the POS system 12, and then go to the physical storefront to attend the interactive class with the coach C1 face to face. According to the O2O activity-oriented studying method accomplished by the network platform 11 and the physical storefront whereon the POS system 12 is disposed, the studying method can fully utilize SoLoMo develop platform and related commercial mode. Thus, the face-to-face interaction and direct participation are irreplaceable activities of the system of the coach and the specific students. “Follow my steps” and “Learn as you go” are main principles of the activity-oriented studying method.

In step S25, after the interactive class of the user A1 and the coach C1, the user A1 can update the study record via the member central system 112 of the network platform 11, and the coach C1 can grade the user A1 and record the study record of the user A1 via the member central system 112 of the network platform 11. The study record can be recorded by characters, photos, voice and images. Content of the study record can include geography information, personal relationship, and notes or conversation during the class. The private study record can be stored in the member central system 112 of the network platform 11 by cloud technology. The coach C1 can adjust the studying skill, even the originally personal course of the user A1 or original content of the personal teaching material, according to studying progress and feedback of the user A1 during the class. Further, the coach C1 can set a target according to a situation of the user A1 in the interactive class, so that the user A1 can study voluntarily according to the target after leaving the physical storefront and further can update the study record via the member central system 112 of the network platform 11.

In step 26, as an achievement of the target, the user A1 can selectively make an e-book of the used personal course, the personal teaching material and the related study record via the data central system 111 of the network platform 11 for selling on the network platform. Because everyone can select different sequence or different combination of the teaching materials according to the individual situation, it is to say, different training teaching materials can be made by different persons from the same courses. The commercial mode can not be afforded in the conventional publication structure, however, the said commercial mode can be succeed in the online publication structure due to low cost of the reproduction and the slotting fee.

In step 27, the coach C1 can rapidly make an achievement of the taught user and the related study record via the data central system 111 of the network platform 11 for advertisement via the network platform 11. Although experiences of individual users are different, the study result can determine whether the teacher-to-student relation is succeeded or not. Comparison of transform of the user can show value of the coach. The system of the coach and the specific users (the teacher-to-student relation) is advertised by colloquial dissemination, the activity-oriented studying method of the present invention can provide preferred market competition.

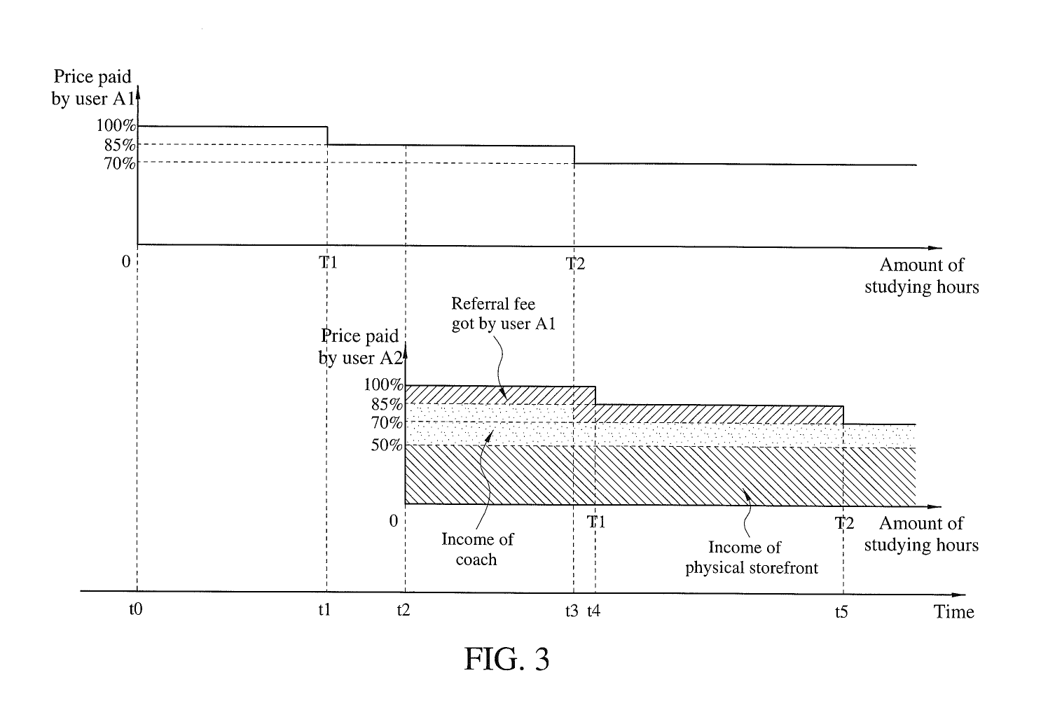

FIG. 3 is a diagram of paying the referral fee of the O2O activity-oriented studying method according to the embodiment of the present invention. Referring to FIG. 3, the relation between the referee and the user belongs to the relation between an upline and a downline of the direct selling mode, so that a grant of the referral fee conforms to a grant of the direct selling mode. For example, when the user A1 attends the O2O activity-oriented studying system 1 at time t0, the course is obtained by original price. The user A1 further can obtain the course by the price with 15% off at time t1 because an amount of the studying hours is T1, and further can obtain the course by the price with 30% off at time t2 because the amount of the studying hours is T2.

When the user A1 recommends the user A2 to be the member at time t2, the user A2 obtains the course by the original price. During time t2 to time t3, fifty percentage of the original price paid by the user A2 is income of the physical storefront, thirty-five percentage of the original price paid by the user A2 is paid to the coach, and fifteen percentage of the original price paid by the user A2 is the referral fee for the referee (the user A1). Then, during time t3 to time t4, fifty percentage of the original price paid by the user A2 is the income of the physical storefront, twenty percentage of the original price paid by the user A2 is paid to the coach, and thirty percentage of the original price paid by the user A2 is the referral fee for the referee (the user A1).

When the user A2 can obtain the course by the price with 15% off at time t4 because the amount of the studying hours is T1, fifty percentage of the original price paid by the user A2 is the income of the physical storefront, twenty percentage of the original price paid by the user A2 is paid to the coach, and fifteen percentage of the original price paid by the user A2 is the referral fee for the referee (the user A1). When the user A2 can obtain the course by the price with 30% off at time t5 because the amount of the studying hours is T2, fifty percentage of the original price paid by the user A2 is the income of the physical storefront, twenty percentage of the original price paid by the user A2 is paid to the coach, and the referee (the user A1) can not get the referral fee.

In conclusion, the O2O activity-oriented studying method of the present invention can have members by verbal recommendation, and the interpersonal relationship can form the direct selling community of electronic publication. The referee recommends the coach and the course to the other users to obtain the referral fee. The coach obtains the income, such as the fee of copyright, by practical training, and further obtains the referral fee by recommendation of the personal teaching material. The publisher obtains the copyright fee of the personal teaching material by the user and the selling fee of the e-book made by the user. The interpersonal relationship, study history and consumer behavior can be stored in the network platform by the cloud technology for market selling activity. An author can determine whether the personal information is shared or not, and statistical data can be reference of the market selling activity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An activity-oriented studying method in an online-to-offline (O2O) manner suitable for athlete training, language learning, weight management, health management, potential development or in-depth travel, the activity-oriented studying method in the O2O manner comprising:
providing a network platform and a physical storefront;
selecting a coach on the network platform by a user;
recommending a personal course to the user according to a study record of the user on the network platform by the coach, the personal course comprising a personal teaching material, and the personal teaching material comprising a part of content or whole content of at least one basic teaching material;
confirming the personal course on the network platform by the user, so that the user attends an interactive class with the coach face to face in the physical storefront;
updating the study record via the network platform by the user and/or grading the user via the network platform so as to record a grade of the user into the study record by the coach.

2. The activity-oriented studying method in the O2O manner of claim 1, further comprising:
setting a target according to a situation of the user in the interactive class by the coach;
studying voluntarily according to the target by the user after leaving the physical storefront and updating the study record via the network platform.

3. The activity-oriented studying method in the O2O manner of claim 1, further comprising:
selecting the coach or the personal course via the network platform according to a referee by the user, wherein the referee has attended the interactive class;
providing a referral fee to the referee by the network platform because the user selects the coach or the personal course due to recommendation of the referee.

4. The activity-oriented studying method in the O2O manner of claim 3, wherein relation between the referee and the user belongs to relation between an upline and a downline of a direct selling mode, and a grant of the referral fee conforms to a grant of the direct selling mode.

5. The activity-oriented studying method in the O2O manner of claim 1, further comprising:
making an achievement of the taught user and the related study record via the network platform by the coach for advertisement.

6. The activity-oriented studying method in the O2O manner of claim 1, further comprising:
making an e-book of the used personal course, the personal teaching material and the related study record via the network platform by the user for selling on the network platform.

7. The activity-oriented studying method in the O2O manner of claim 1, further comprising:
providing at least one point-of-sale (POS) system disposed on the corresponding physical storefront and communicated with the network platform;
providing at least one terminal device with network function to be communicated with the corresponding POS system, so as to help the user to obtain identification via the POS system and therefore consume in the physical storefront or attend the interactive class with the coach, or so as to help the user to login the POS system or the network platform for searching and selecting the coach or the personal course and for updating the study record of the user.

8. The activity-oriented studying method in the O2O manner of claim 7, wherein the network platform comprises:
at least one member central system, each member central system being in charge of member management and data collection of an organization, each member central system being communicated with the POS system disposed on at least one physical storefront of multiple physical storefronts of the organization;
a data central system for analysis of information from the at least one member central system, so as to generate an advertisement or a publication in electronic format to the at least one member central system or to its member.
